(19) United States
(12) Patent Application Publication
(10) Pub. No.: US 2007/0002848 A1
(43) Pub. Date: Jan. 4, 2007

(54) Packet relay apparatus and packet relay method

(75) Inventors: Hideyuki Kudou, Fukuoka (JP); Takeshi Miyaura, Fukuoka (JP); Marika Kawano, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/233,649

(22) Filed: Sep. 23, 2005

(30) Foreign Application Priority Data
Jun. 30, 2005 (JP) 2005-192482

(51) Int. Cl. H04L 12/50

(52) U.S. Cl. 370/378

(57) ABSTRACT

An output-band control unit extracts delay information indicating a delay state of a packet from a packet received, and controls a setting of an output band of the packet based on the delay information. A packet-transmission control unit updates the delay information based on the output band of which the setting is controlled by the output-band control unit and an internal delay that occurs internally with respect to a packet output in the output band, and transmits the packet with the delay information updated.

### BACKGROUND OF THE INVENTION

1. Field of the Invention

The present invention relates to a technology for relaying a packet in a packet network.

2. Description of the Related Art

In general, a data transmission is a main concern in Internet Protocol (IP) communications. While many expansion protocols to guarantee quality of service (QoS) of communications are developed, what is guaranteed is a communication band based on the number of packets transmitted per unit time (see, for example, Japanese Patent Application Laid-open No. 2002-7281066).

FIG. 9 is a schematic of an example of an IP network. In this example, a terminal 101 and a terminal 104 are carrying out voice-based data communications using IP telephones. A terminal 102 and a terminal 105, and a terminal 103 and the terminal 105 are carrying out data communications using a telecommunication network (TELNET) or a Hyper Text Transport Protocol (HTTP).

Packet switches 106 to 114 in the IP network performs a relay of respective data, and a data output control (a QoS control) by placing a high priority to voice communication from the terminal 101 to the terminal 104 and placing a low priority to other data communications.

FIG. 10 is a functional block diagram for illustrating QoS operation of a packet switch 109 shown in FIG. 9. A flow identifying unit 201 receives packets from the terminals 101 to 103, and identifies kinds of information and data that the terminals are communicating to confirm whether the terminals are carrying out voice communications or data communications, in order to determine priorities of the packets and output bands of the packets. The flow identifying unit 201 allocates the packets to queues 10 to 30 based on a result of the identification.

Priorities of the queues and output bands are set in advance to the queues 10 to 30 to which the packets are allocated. A transmission controller 205 reads packets that are determined to be able to be output, and outputs these packets.

Because the communications between the terminal 101 and the terminal 104 are voice communications in this example, the flow identifying unit 201 allocates the packets transmitted from the terminal 101 to a high-priority queue. Because the communications between the terminal 102, the terminal 103, and the terminal 105 are data communications, the flow identifying unit 201 allocates the packets transmitted from the terminals 102 and 103 to a low-priority queue. Based on the above allocations, voice communications are protected from being affected by data communications, and restriction of data output is avoided as far as possible.

However, the QoS processing based on the conventional packet switch has the following problems. The packet switch 109 shown in FIG. 9 needs to receive data from the terminals 101 to 103 and transmit the data received to the packet switch 110. When a band capable of transmitting the data received from the terminals 101 to 103 to the packet switch 110 is narrow, a data congestion occurs. Even when a voice communication from the terminal 101 to the terminal 104 have a high priority, a delay in the output data occurs.

In other words, while the packet switch 110 in the subsequent stage executes a QoS control to the received data and places a high priority to the voice communication from the terminal 101 to the terminal 104, the packet switch 110 does not recognize that an output delay occurs in the preceding stage. The packet switch 110 can execute a closed QoS control only within the packet switch 110. Therefore, the data is transmitted to the terminal 104 in the state that the data output is delayed in the packet switch 109. Consequently, a fluctuation of packet delay occurs.

FIG. 11 is a schematic for illustrating a principle of an occurrence of a fluctuation of packet delay. Voice data is transmitted to the packet switch 109 at an equal interval. However, the output of the voice data from the packet switch 109 is delayed by the data from the packet switch 112 and the packet switch 114. Therefore, the interval between the voice data and the preceding data is large and the interval between the voice data and the subsequent data becomes small, thereby generating a fluctuation of data delay. As a result, the quality of the voice communications between the terminal 101 and the terminal 104 is degraded.

Applications that require the guarantee of quality of communication includes not only a real-time voice communication such as a telephone conversation and a video data, but also a real-time communication such as a robot remote operation and a remote medical care (operation). In these applications, a network free from a drop or delay of data and a fluctuation of delay is strongly desired.

### SUMMARY OF THE INVENTION

It is an object of the present invention to at least solve the problems in the conventional technology.

An apparatus according to one aspect of the present invention, which is for relaying a packet in a packet network, includes an output-band control unit that extracts delay information indicating a delay state of a packet from a packet received, and controls a setting of an output band of the packet based on the delay information; and a packet-transmission control unit that updates the delay information based on the output band of which the setting is controlled by the output-band control unit and an internal delay that occurs internally with respect to a packet output in the output band, and transmits the packet with the delay information updated.

A method according to another aspect of the present invention, which is for relaying a packet in a packet network, includes output-band controlling including extracting delay information indicating a delay state of a packet from a packet received, and controlling a setting of an output band of the packet based on the delay information; and packet-transmission controlling including updating the delay information based on the output band of which the setting is controlled at the output-band controlling and an internal delay that occurs internally with respect to a packet output in the output band, and transmitting the packet with the delay information updated.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a QoS guarantee system using a packet switch according to an embodiment of the present invention;

FIG. 2 is a functional block diagram of the packet switch according to the present embodiment;

FIG. 3 is an example of a band conversion table;

FIGS. 4A and FIG. 4B are schematics for illustrating a dequeue operation by a transmission controller when a delay occurs;

FIG. 5 is a schematic for illustrating a delay-time insertion processing by the packet switch according to the present embodiment;

FIG. 6 is a schematic for illustrating a delay-time recovery processing by the packet switch according to the present embodiment;

FIG. 7 is a flowchart of a processing procedure of a queue shaper shown in FIG. 2;

FIG. 8 is a flowchart of a processing procedure of a port shaper shown in FIG. 2;

FIG. 9 is a schematic of an example of an IP network;

FIG. 10 is a functional block diagram for illustrating QoS operation of a packet switch shown in FIG. 9; and

FIG. 11 is a schematic for illustrating a principle of an occurrence of a fluctuation of packet delay.

### DETAILED DESCRIPTION OF THE PREFERRED EMBODIMENTS

Exemplary embodiments of the present invention will be explained below with reference to the accompanying drawings.

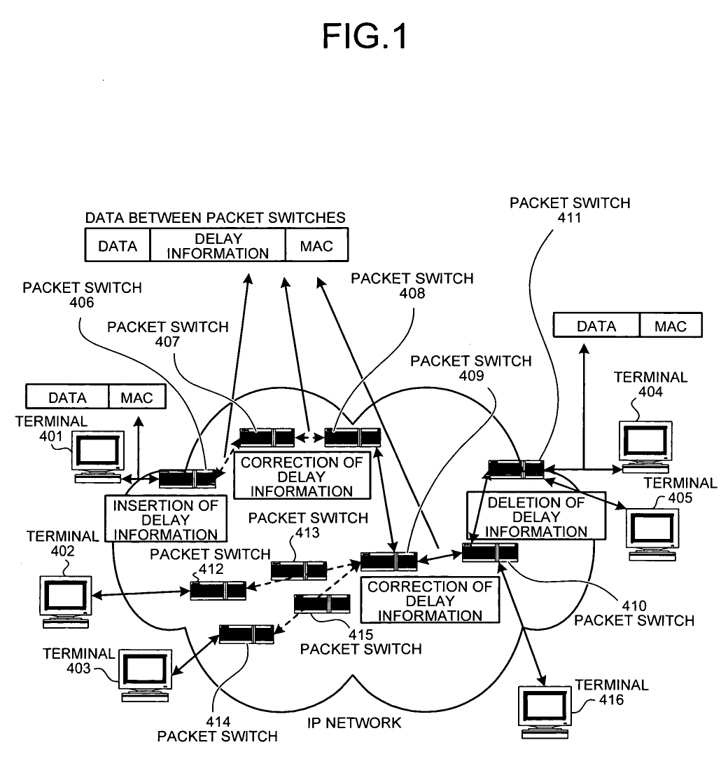

FIG. 1 is a schematic of a QoS guarantee system using a packet switch according to an embodiment of the present invention.

A terminal 401 and a terminal 404 are carrying out voice-based data communications using IP telephones. A terminal 402 and a terminal 405, and a terminal 403 and the terminal 405 are carrying out data communications using the TELNET or the HTTP.

When a packet switch 406 at an edge of an IP network receives voice data transmitted from the terminal 401, the packet switch 406 identifies the received data, and determines whether this voice data requires a correction of a fluctuation. When it is determined that the voice data requires a correction of the fluctuation, the packet switch 406 inserts delay information showing a delay into a fixed position of a packet.

The delay information to be inserted is delay time that expresses in a code whether data is delayed or advanced from normal transmission time of the data, and expresses in a numerical value how much the data is delayed or advanced from this required transmission time. The delay information includes a tag indicating the delay information and delay time. In this example, data congestion does not occur in the packet switch 406. Therefore, delay time “0” that indicates no delay is inserted, and the delay information is inserted into between the data and a media access control (MAC) address.

A packet switch 407 to a packet switch 409 update delay information that is included in the received packet. Specifically, because data congestion does not occur in the packet switch 407 and the packet switch 408, there is no delay in the data. Therefore, the packet switch 407 and the packet switch 408 do not update the delay time.

On the other hand, in the packet switch 409, data from the terminal 402 and the terminal 403 are congested, and this congestion generates a delay in the data from the terminal 401. Therefore, the packet switch 409 updates the delay time, and transmits the packet having the updated delay time to a packet switch 410, thereby informing the packet switch 410 of the delay time.

The packet switch 410 receives the packet, and recognizes delay time of the data received from the packet switch 409 based on the delay information included in the received packet. The packet switch 410 schedules a data transmission based on the delay information, and recovers the delay time.

When the delay time can be completely recovered as a result of the scheduling, the packet switch 410 updates the delay information to indicate that there is no data delay, and transmits the packet having the updated delay information to the next packet switch 411. On the other hand, when the delay time cannot be completely recovered as a result of the scheduling, the packet switch 410 updates the delay information by setting a difference between the reception delay time and time recovered in the packet switch 410, as updated delay time, and transmits the packet having the updated delay information to the next packet switch 411.

The packet switch 411 receives the packet, and when there is no data delay in the delay information contained in the received packet, the packet switch 411 deletes the delay time, and transmits the packet to the terminal 404. On the other hand, when the data is delayed, the packet switch 411 schedules a data transmission to recover the delay time, deletes the delay information, and transmits the packet to the terminal 404.

As explained above, in the IP network according to the present embodiment, the packet switches exchange data delay information with each other, and make it possible to correct a data delay in the total network, thereby preventing a fluctuation of delay. Even when one packet switch cannot correct the data delay, this packet switch can transmit delay information of the total network to the next packet switch, by updating the delay information. Consequently, plural packet switches can correct the delay at stages.

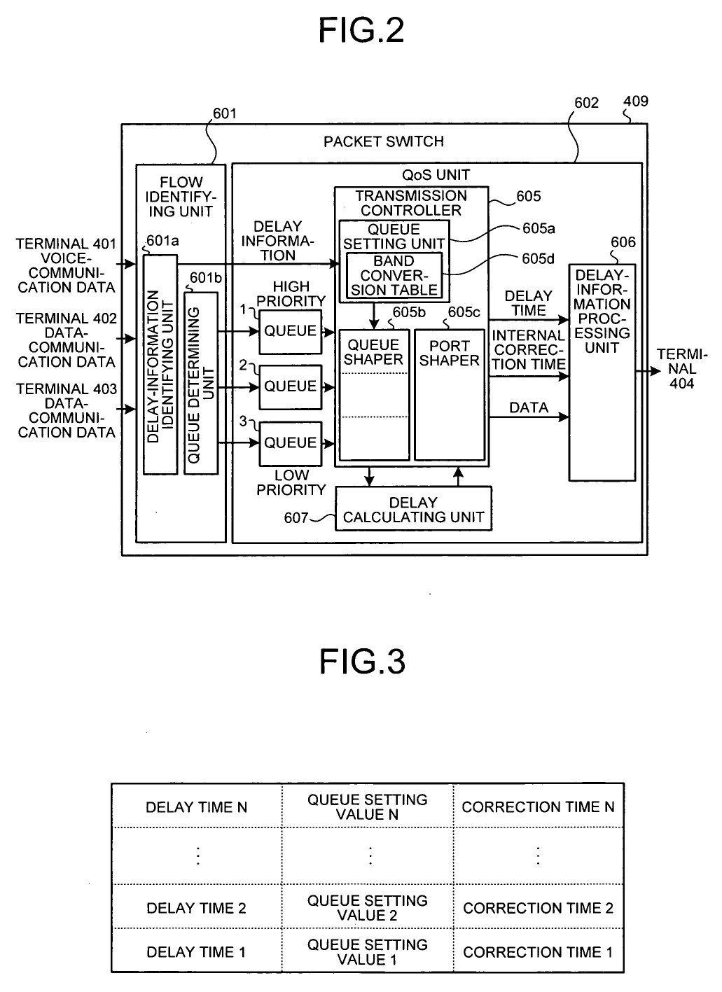

FIG. 2 is a functional block diagram of the packet switch 409 according to the present embodiment. The packet switch 409 includes a flow identifying unit 601 and a QoS unit 602.

The flow identifying unit 601 determines a priority of a packet and an output band of the packet, by identifying a type of data contained in a received packet whether the data is voice data used by the IP telephone or data for data communications by the TELNET, and determines a queue into which the packet is to be entered (enqueued) based on the determined priority and the output band. The flow identifying unit 601 has a delay information identifying unit 601a and a queue determining unit 601b.

The delay information identifying unit 601a determines a priority of a packet and an output band of the packet, by identifying a type of data contained in a received packet, and identifies whether the packet contains delay information. When the packet contains delay information, the delay information identifying unit 601a extracts the delay information from the packet, and delivers the extracted delay information to the QoS unit 602.

The queue determining unit 601b determines a queue into which the packet is to be inserted based on the priority and the output band that are determined, and enters the packet into the determined queue.

The QoS unit 602 executes the QoS control based on a result of the identification carried out by the flow identifying unit 601 and the delay information received from the flow identifying unit 601. The QoS unit 602 has queues 1 to 3, a transmission controller 605, a delay-information processing unit 606, and a delay calculating unit 607.

The queues 1 to 3 are used into which the received packet is entered. The queue 1 has a highest priority, and the queue 3 has a lowest priority. The queue determining unit 601b enters the packet received from the terminal 401 into the queue 1, because the data from the terminal 401 is voice data using the IP telephone. The queue determining unit 601b enters the packet received from the terminals 402 and 403 into the queue 3, because the data from the terminals 402 and 403 are data for data communication.

The transmission controller 605 detects entering of packets into the queues, and schedules a packet output based on the setting of each queue. When the packet can be output, the transmission controller 605 reads the packet from the queue, and transmits the packet. The transmission controller 605 has a queue setting unit 605a, a queue shaper 605b, and a port shaper 605c.

The queue setting unit 605a receives delay information from the flow identifying unit 601, and sets an output band of a queue based on the received delay information. Specifically, the queue setting unit 605a obtains a queue set value using a band conversion table 605d, and instructs the queue shaper 605b to change the queue set value.

The band conversion table 605d stores a queue set value corresponding to delay time. FIG. 3 is an example of a band conversion table 605d. The band conversion table 605d stores queue set values and correction times corresponding to delay times. The correction time is obtained based on a change of the queue set value.

As explained above, the queue setting unit 605a changes a setting of the output band of a queue using the delay information received from the flow identifying unit 601 and the band conversion table 605d. With this arrangement, a delay that occurs in other packet switches can be recovered.

The queue shaper 605b is a controller that controls the output of a packet from each queue (dequeue). The queue shaper 605b requests the port shaper 605c to control the output of a packet from each queue based on a queue set value assigned by the queue setting unit 605a.

The port shaper 605c manages the band of the port to which a packet is output. The port shaper 605c controls the output of a packet from each queue based on a dequeue request from the queue shaper 605b, and delivers the packet to the delay-information processing unit 606.

The port shaper 605c calculates internal correction time using the delay calculating unit 607, and delivers the calculated internal correction time to the delay-information processing unit 606. The internal correction time is a difference between delay time within the own packet switch and correction time according to a change of a queue setting. The internal correction time is used to calculate delay time to be inserted into a transmission packet from delay time contained in the received packet.

The delay-information processing unit 606 transmits a packet by processing delay information. A packet switch at the edge of the network inserts delay information at the data entrance, and deletes the delay information at the data exit. A packet switch at other than the edge updates the delay information.

The delay calculating unit 607 calculates internal correction time based on delay time within the own packet switch and correction time according to a change of a queue setting. The time delayed in the own packet switch is from when it becomes possible to dequeue until when the packet can be actually output from the output port. The correction time according to the change of the queue setting is the one stored in the band conversion table 605d.

The delay calculating unit 607 delivers the calculated internal correction time to the delay-information processing unit 606 via the transmission controller 605. The delay-information processing unit 606 updates the delay information based on the internal correction time, and delivers the packet containing the updated delay information to the next packet switch.

As explained above, the delay calculating unit 607 calculates the internal correction time within the own packet switch. The delay-information processing unit 606 calculates updated delay time as an update of the delay time using the internal correction time, and updates the delay time using the updated delay time. With this arrangement, a delay that occurs in a certain packet switch can be corrected in the total network.

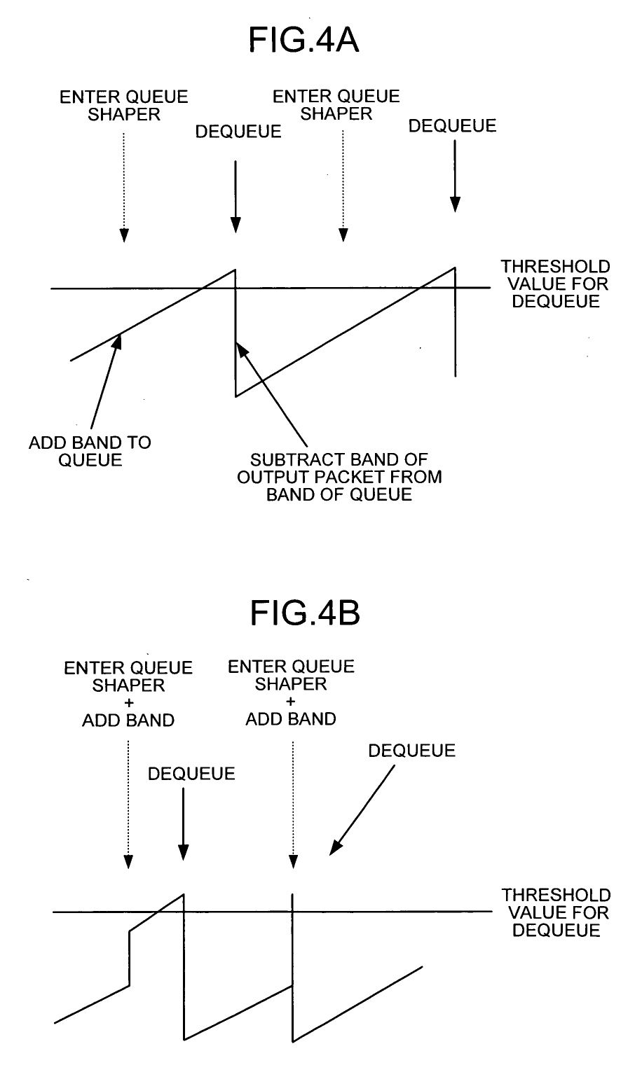

FIGS. 4A and FIG. 4B are schematics for illustrating a dequeue operation by a transmission controller 605 when a delay occurs. FIG. 4A is corresponding to a conventional flow, and FIG. 4B is corresponding to a flow according to the present embodiment.

As shown in FIG. 4A, conventionally, a queue shaper adds a band to a queue to match the setting of the queue. When a packet can be output using this band, the packet is dequeued and the band used to output the packet is subtracted from the band of the queue, and this operation is repeated. Therefore, even when a delay occurs in the received packet, the transmission controller carries out dequeue in a similar manner to that when a delay does not occur, based on the band set to the queue.

On the other hand, according to the present embodiment, as shown in FIG. 4B, the queue setting unit 605a changes the setting of the output band of the queue based on delay information. With this arrangement, a band of the queue is increased to quickly reach a band where dequeue is possible.

As explained above, according to the present embodiment, the queue setting unit 605a changes the setting of the output band of the queue based on the delay information, thereby increasing a band to the queue. In this way, time required to output a packet from the queue can be shortened. Consequently, a delay that occurs in other packet switch can be recovered.

A delay-time insertion processing is an insertion of delay time by updating the delay time when a transmission of a packet is delayed due to data congestion in the port shaper 605c, even when the delay time of the received packet is “0”.

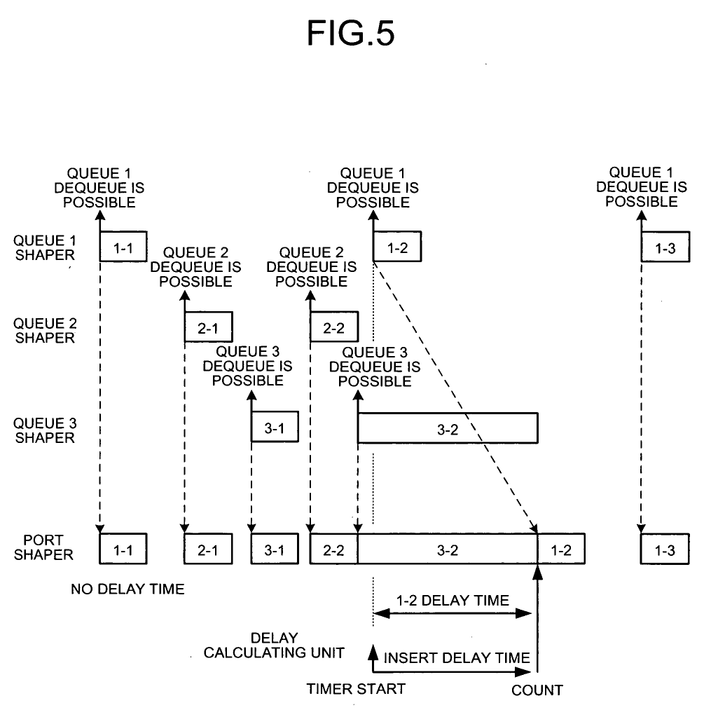

FIG. 5 is a schematic for illustrating a delay-time insertion processing by the packet switch according to the present embodiment. The queue shaper 605b calculates time taken to output a packet from each queue based on the band set to each queue in advance. When a packet can be output from the queue, the queue shaper 605b notifies the port shaper 605c that the packet can be dequeued.

The port shaper 605c receives a notice from the queue shaper 605c that the packet can be dequeued. When the band of the output port is idle, the port shaper 605c reads the packet from the queue, and outputs the packet.

The packets that can be dequeued and of which data can be output at the same time based on idle output ports are packets 1-1, 2-1, 3-1, 2-2, and 3-2. Although a packet 1-2 can be output from the queue in the set band, the packet 1-2 becomes in a state of being output because the packet 3-2 that is output in advance has a large packet length and this packet occupies the band of the output port. In other words, the packet 1-2 can be output after the packet 3-2 is output.

The delay calculating unit 607 counts time when the packet 1-2 can be dequeued based on the notice of the packet 1-2, and measures delay time until when data can be output. The delay calculating unit 607 delivers the measured delay time to the delay-information processing unit 606 via the transmission controller 605, as internal correction time. The delay-information processing unit 606 updates the delay information using the delay time.

As explained above, the delay-information processing unit 606 inserts the delay time measured by the delay calculating unit 607 into the packet as delay information. The next packet switch can recover the delay using the delay information.

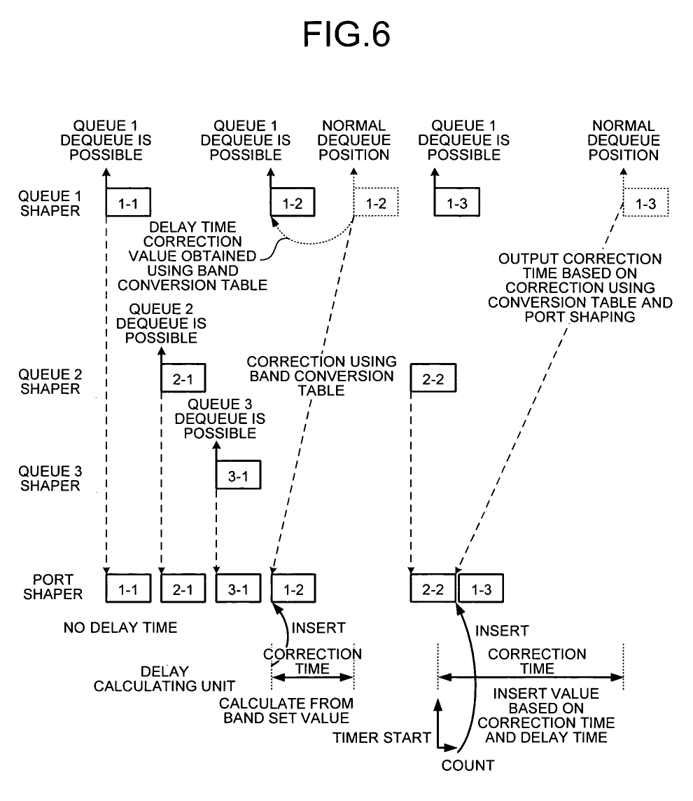

FIG. 6 is a schematic for illustrating a delay-time recovery processing by the packet switch according to the present embodiment. According to the present embodiment, the packet switch detects that a data delay does not occur in delay information contained in the received packet 1-1, executes a QoS processing using a normal queue set value, and outputs data.

The packet switch detects that a data delay occurs in delay information contained in the received packet 1-2. The transmission controller 605 searches the band conversion table 605d for a queue setting value and correction time, using delay time in the delay information as a search key.

The transmission controller 605 changes the setting of the band of the queue using the queue setting value obtained by searching the band conversion table 605d. In order to output data as quickly as possible, the band of the queue is set large, thereby quickly outputting the packet from the queue.

The transmission controller 605 transmits correction time obtained by searching the band conversion table 605d to the delay calculating unit 607 to calculate the internal correction time. In this example, there is no data congestion in the output port. A request for outputting a packet from the queue and a data output to the port are carried out simultaneously. Therefore, the internal correction time is calculated based on only the correction time obtained from the band conversion table 605d.

The transmission controller 605 transmits the correction time obtained from the band conversion table 605d to the delay calculating unit 607 at the same time as when the port shaper 605c outputs the packet 1-2. The delay calculating unit 607 calculates the internal correction time. The delay-information processing unit 606 calculates the reception delay time minus the internal correction time, using the internal correction time calculated by the delay calculating unit 607 and the reception delay time within the received delay information. The delay-information processing unit 606 updates the delay information based on this calculation, and outputs the packet.

The operation carried out to the received packet 103 is the same as that carried out to the packet 1-2 for the period from when a queue setting is changed based on a result of searching the band conversion table 605d until when the packet is output from the queue. However, at the time of outputting the packet 1-3 to the port, the packet 2-2 is being output. Therefore, the output of the packet to the port is in standby mode. In this case, the delay calculating unit 607 needs to measure time from when the packet can be output from the queue until when the data can be actually output.

Therefore, triggered by the notice that the packet can be output from the queue, the delay calculating unit 607 counts time from this time until when the data can be output from the port. The delay calculating unit 607 calculates a difference between the data output standby time as a result of the counting and the correction time obtained from the band conversion table 605d, as the internal correction time. The delay calculating unit 607 outputs this internal correction time to the delay-information processing unit 606 via the transmission controller 605. The delay-information processing unit 606 updates the difference between the reception delay time and the internal correction time calculated by the delay calculating unit 607, as updated delay time of the packet, and outputs the packet.

As explained above, the delay calculating unit 607 calculates the difference between the data output standby time obtained by counting and the correction time obtained from the band conversion table 605d, as the internal correction time. The delay-information processing unit 606 updates the difference between the reception delay time and the internal correction time calculated by the delay calculating unit 607, as the updated delay time. Consequently, the delay information of the packet can be updated, and the recovered delay time can be reflected in the delay time.

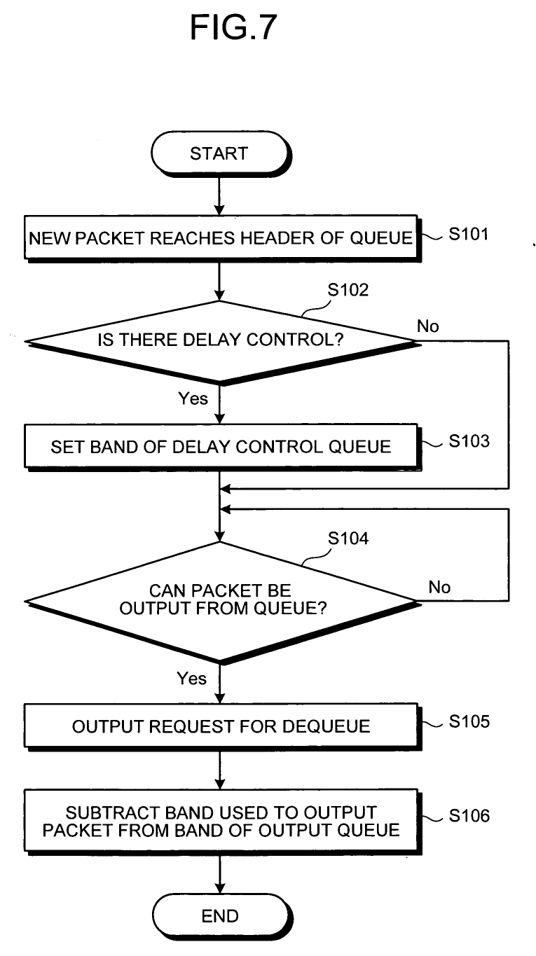

FIG. 7 is a flowchart of a processing procedure of a queue shaper 605b shown in FIG. 2. When a new packet reaches the header of a queue (step S101), the queue shaper 605b determines whether this queue is a delay control queue to carrying out a delay control based on delay information (step S102).

When the queue is a delay control queue to carrying out a delay control based on delay information, the queue shaper 605b sets the band of the delay control queue based on the instruction from the queue setting unit 650a (step S103).

When a packet can be output from the queue (step S104: Yes), the queue shaper request the port shaper 605c to output the packet from the queue (step S105), and subtracts the band used to output the packet, from the band of the queue (step S106).

The queue shaper 605b sets the band of the delay control queue based on the instruction from the queue setting unit 605a, thereby recovering a delay occurred in other packet switches.

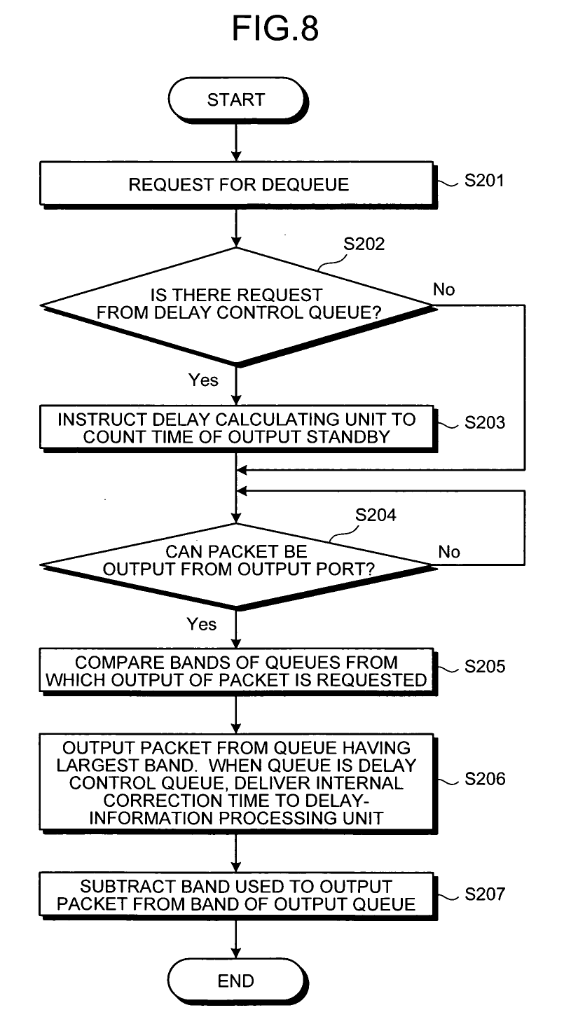

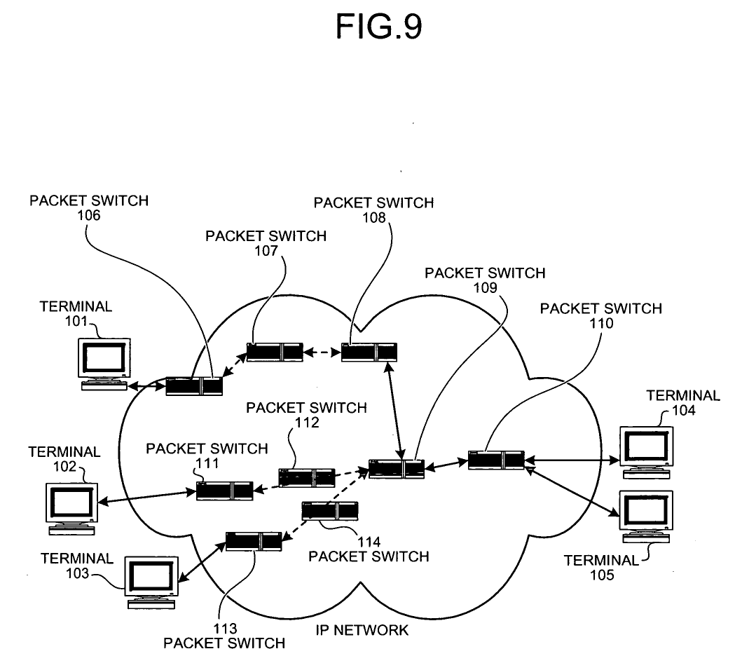

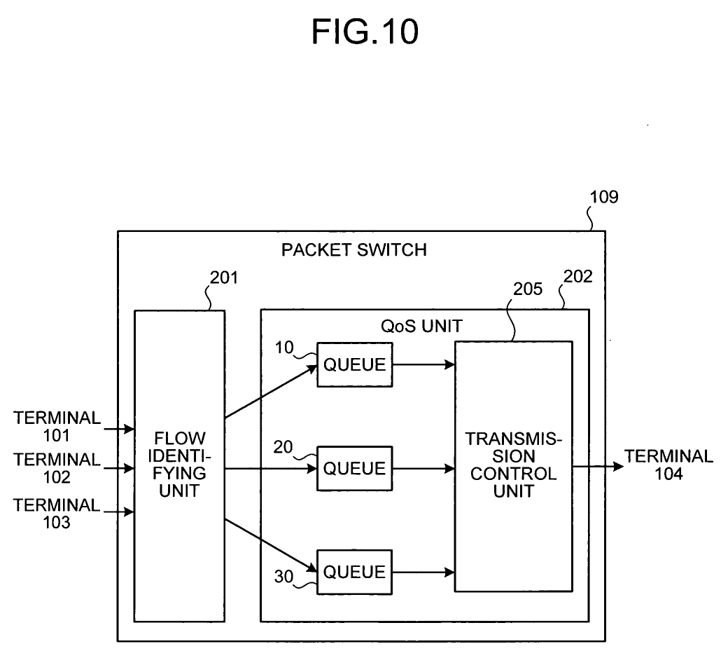

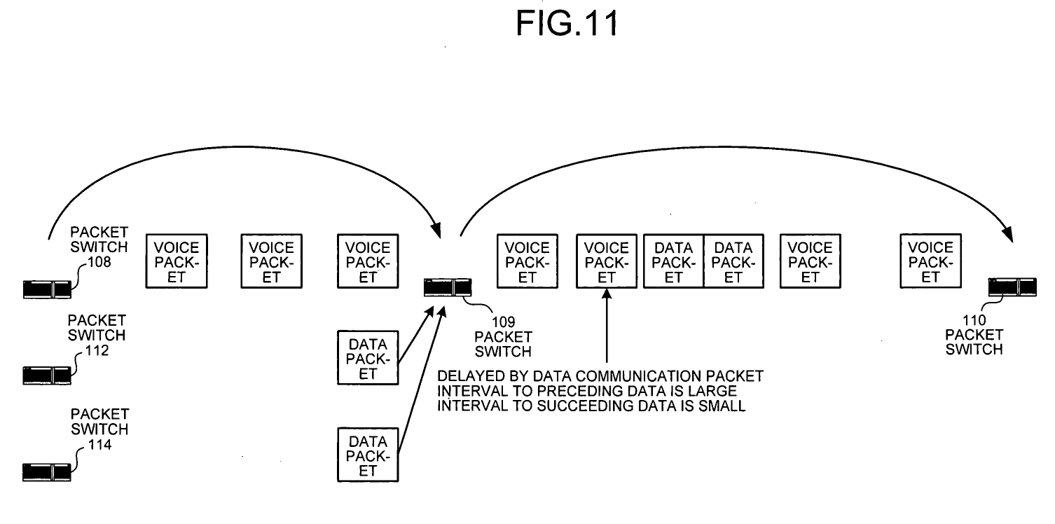

FIG. 8 is a flowchart of a processing procedure of a port shaper 605c shown in FIG. 2. When there is a dequeue request from the queue shaper 605b (step S201), the port shaper 605c determines whether there is a dequeue request from the delay control queue (step S202). When there is a dequeue request from the delay control queue, the port shaper 605c instructs the delay calculating unit 607 to count time of the output standby (step S203).

When it becomes possible to output a packet from the output port (step S204: Yes), the port shaper 605c compares bands of the queues from which an output of a packet is requested (step S205), and outputs a packet from a queue having a largest band. When the queue from which a packet is output is a delay control queue, the port shaper 605c obtains internal correction time from the delay calculating unit 607, and delivers the internal correction time to the delay-information processing unit 606 (step S206). The port shaper subtracts a band used to output the packet from the band of the queue (step S207).

At the time of outputting a packet from the delay control queue, the port shaper 605c delivers the internal correction time calculated by the delay calculating unit 607 to the delay-information processing unit 606. Consequently, the delay-information processing unit 606 can update the delay information and transmit the packet.

As described above, according to the present embodiment, delay information is inserted into a packet that is transferred between packet switches in the IP network, and the QoS control is carried out using the delay information. Therefore, a delay that occurs in a certain packet switch can be recovered in the total IP network. Specifically, the flow identifying unit 601 extracts delay information from a received packet, and delivers the extracted delay information to the transmission controller 605. The transmission controller 605 changes the setting of the band of the queue based on the delay information, and calculates the internal correction time with the delay calculating unit 607. The delay-information processing unit 606 updates the delay information using the internal correction time. Consequently, one packet switch can recover a data transmission delay that occurs in another packet switch.

While packet switches for transferring a packet in the IP network are explained in the present embodiment, the present invention can be also applied to other devices. For example, the invention can be similarly applied to a packet relay apparatus that transfers a packet in a network in which data is transferred using a packet.

According to the present invention, since the occurrence of a fluctuation of data delay can be prevented in the total packet network, communication quality can be improved.

Furthermore, according to the present invention, since each packet relay apparatus recovers a delay corresponding to delay time, communication quality can be improved in the total network.

Moreover, according to the present invention, since internal correction time can be accurately calculated, accurate delay time can be transmitted between the packet relay apparatuses.

Furthermore, according to the present invention, since an unnecessary setting of an output band can be prevented, it is possible to prevent an unnecessary setting control from affecting a network.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for relaying a packet in a packet network, the apparatus comprising:
an output-band control unit that extracts delay information indicating a delay state of a packet from a packet received, and controls a setting of an output band of the packet based on the delay information; and
a packet-transmission control unit that updates the delay information based on the output band of which the setting is controlled by the output-band control unit and an internal delay that occurs internally with respect to a packet output in the output band, and transmits the packet with the delay information updated.

2. The apparatus according to claim 1, wherein
the delay information is a delay time,
the packet-transmission control unit includes
a queue shaper that controls a dequeue of the packet according to each packet queue that is provided for a priority of the packet;
a port shaper that performs the dequeue of the packet in response to a request for the dequeue of the packet from the queue shaper;
a delay-time calculating unit that calculates a correction time for the delay time, as an internal correction time, based on the output band and the internal delay; and
a packet transmitting unit that calculates updated delay time from the internal correction time, inserts the updated delay time calculated into a packet that is dequeued by the port shaper, and transmits the packet with the updated delay time inserted, and
the output-band control unit controls a setting of the output band of a dequeue that is controlled by the queue shaper.

3. The apparatus according to claim 2, wherein the delay-time calculating unit calculates the internal correction time based on a correction time corresponding to the delay time and a time from an issuing of the request for the dequeue of the packet to a transmission of the packet in response to the request.

4. The apparatus according to claim 1, further comprising:
a setting-control determining unit that determines whether to perform the setting of the output band for a packet received, wherein
the output-band control unit controls the setting of the output band of a packet for which the setting-control determining unit determines to perform the setting of the output band.

5. The apparatus according to claim 1, wherein the output-band control unit extracts the delay information from the packet using a tag that indicates the delay information.

6. A method of relaying a packet in a packet network, the method comprising:
output-band controlling including
extracting delay information indicating a delay state of a packet from a packet received; and
controlling a setting of an output band of the packet based on the delay information; and
packet-transmission controlling including
updating the delay information based on the output band of which the setting is controlled at the output-band controlling and an internal delay that occurs internally with respect to a packet output in the output band; and
transmitting the packet with the delay information updated.

7. The method according to claim 6, wherein
the delay information is a delay time, and
the packet-transmission controlling includes
controlling including a queue shaper controlling a dequeue of the packet according to each packet queue that is provided for a priority of the packet;
performing the dequeue of the packet in response to a request for the dequeue of the packet from the queue shaper;
calculating a correction time for the delay time, as an internal correction time, based on the output band and the internal delay;
calculating updated delay time from the internal correction time;
inserting the updated delay time calculated into a packet that is dequeued by the port shaper; and
transmitting the packet with the updated delay time inserted, and
the output-band controlling includes controlling a setting of the output band of a dequeue that is controlled by the queue shaper.

8. The method according to claim 7, wherein the calculating a correction time included calculating the internal correction time based on a correction time corresponding to the delay time and a time from an issuing of the request for the dequeue of the packet to a transmission of the packet in response to the request.

9. The method according to claim 6, further comprising:
determining whether to perform the setting of the output band for a packet received, wherein
the output-band controlling includes controlling the setting of the output band of a packet for which it is determined to perform the setting of the output band at the determining.

10. The method according to claim 6, wherein the output-band controlling includes extracting the delay information from the packet using a tag that indicates the delay information.
